(19) United States
(12) Patent Application Publication
(10) Pub. No.: US 2026/0048996 A1
(43) Pub. Date: Feb. 19, 2026

(54) METHODS OF MANUFACTURE AND USE OF CALCIUM HYDROXIDE GRANULES FOR CARBON DIOXIDE CAPTURE

(71) Applicant: Heimdal, Inc., San Francisco, CA (US)

(72) Inventors: William Nigel Vickery, London (GB); Christopher Stephen Mitchell, Marietta, GA (US); Marcus Lima, Oxford (GB); Yaser Alhamwy, London (GB); Fraser Christensen, London (GB)

(21) Appl. No.: 19/264,821

(22) Filed: Jul. 9, 2025

Related U.S. Application Data
(60) Provisional application No. 63/682,550, filed on Aug. 13, 2024.

(51) Int. Cl. C01F 11/06; B01D 53/14; B01D 53/62; B01D 53/81

(52) U.S. Cl. CPC C01F 11/06; B01D 53/1481; B01D 53/62; B01D 53/81; B01D 2251/404; B01D 2251/604; B01D 2257/302; B01D 2257/404; B01D 2257/504; B01D 2258/06; C01P 2004/60; C01P 2006/11; C01P 2006/12

(57) ABSTRACT

A method of manufacturing calcium hydroxide (Ca(OH)₂) granules by feeding a volume of crushed limestone into a kiln, wherein the crushed limestone comprises an amount of calcium carbonate. The crushed limestone is heated, via the kiln, to at least 800° C. thereby causing a calcination reaction of the calcium carbonate. About 70.0-99.75% of available CO2 of the crushed limestone is liberated in the calcination reaction of the calcium carbonate (CaCO₃) to calcium oxide (CaO). The liberated CO₂ is captured in a pressurized container. The calcium oxide is cooled and stored in a container and/or a storage area. The calcium oxide is slaked by applying water along with agitation of the calcium oxide thereby making the calcium hydroxide granule.

### CROSS-REFERENCE TO RELATED APPLICATIONS

This application claims the benefit of priority to U.S. Provisional Application No. 63/682,550, filed on Aug. 13, 2024, which is hereby incorporated by reference in its entirety.

### FIELD

The present disclosure relates to carbon dioxide capture, and more particularly to the methods of manufacture and of use of calcium hydroxide granules for carbon dioxide capture.

### SUMMARY

A method of manufacturing calcium hydroxide (Ca(OH)₂) granules by feeding a volume of crushed limestone into a kiln, wherein the crushed limestone comprises an amount of calcium carbonate. The crushed limestone is heated, via the kiln, to at least 800° C. thereby causing a calcination reaction of the calcium carbonate. About 70.0-99.75% of available CO₂ of the crushed limestone is liberated in the calcination reaction of the calcium carbonate (CaCO₃) to calcium oxide (CaO). The liberated CO₂ is captured in a pressurized container. The calcium oxide is cooled and stored in a container and/or a storage area. The calcium oxide is slaked by applying water along with agitation of the calcium oxide thereby making the calcium hydroxide granules.

A method of recovery and recycling of the calcium hydroxide granules where previously applied calcium hydroxide granules may be recovered and recycled. The recycling of the previously applied calcium hydroxide granules creates refreshed or renewed calcium hydroxide granules that may be applied again to a field to capture ambient CO₂. As a result of the recovery and recycling process, the CO₂ that was captured by the previously applied calcium hydroxide granules are extracted from the granules and stored in a storage container, such as in a liquified form. The extracted CO₂ may be transported and stored elsewhere or the extracted CO₂ may be used for other purposes.

Furthermore, the appended claims may serve as a summary of this application.

### BRIEF DESCRIPTION OF THE DRAWINGS

Embodiments of the present disclosure will now be described, by way of example only, with reference to the attached FIGURES.

FIG. 1 depicts a block flow diagram guiding the process flow.

### DETAILED DESCRIPTION

In this specification, reference is made in detail to specific embodiments of the invention. Some of the embodiments or their aspects are illustrated in the drawings.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

In addition, it should be understood that steps of the exemplary methods set forth in this specification can be performed in different orders than the order presented in this specification. Furthermore, some steps of the exemplary methods may be performed in parallel rather than being performed sequentially.

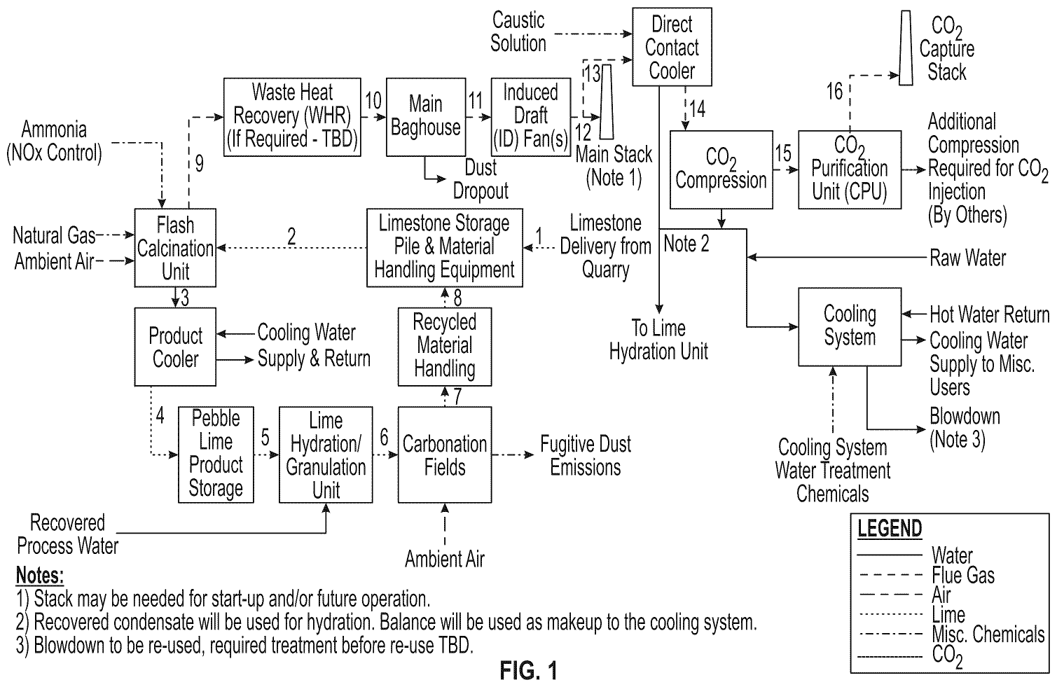

Referring to FIG. 1, the FIGURE depicts a block flow diagram guiding the process flow. The following describes each of the steps from FIG. 1 in more detail.

### Manufacturing Process of Calcium Hydroxide Granules

In some embodiments, quarried limestone is crushed to a size of <10 mm and fed into a kiln for heating and processing. The size to crush the quarried limestone may be dependent on the kiln being used to heat the crushed limestone. In general, the crushed limestone is heated to at least 800° C. to liberate CO₂ from the crushed limestone in a calcination reaction of calcium carbonate (CaCO₃) to calcium oxide (CaO). The CaO is cooled to a desired temperature which may take a period of time. The CaO is slaked by application of water and agitation to the CaO to produce calcium hydroxide granules. In some embodiments, the size of the produced calcium hydroxide granules are larger than the input size of the crushed quarried limestone.

Referring now to FIG. 1, in step 1, quarried limestone (typically <3% calcium hydroxide (Ca(OH)₂)) is mined, loaded, and transported to a processing site. Limestone is stored in piles and/or silos before crushing/screening into adequate size.

In step 2, crushed limestone is fed into a kiln where it is heated to 800° C. Liberating >70.0% of available CO₂ in the calcination reaction of calcium carbonate (CaCO₃) to calcium oxide (CaO). In some embodiments, the size of the crushed limestone (e.g., the fines) is a size of <2 mm. In some embodiments, the size of the crushed limestone is a size of <5 mm. In some embodiments, the size of the crushed limestone is a size of <10 mm.

In steps 3 and 4, CaO is cooled/stored in a buffer silo. In some embodiments, the CaO is cooled to about 100° C. before proceeding to the next step 5. In some embodiments, the CaO is cooled for a period of time ranging from about 1 minute to about 15 minutes.

In step 5, CaO is slaked (water/agitation), making calcium hydroxide (Ca(OH)₂). Ca(OH)₂ is combined with an amount of water (respective to desired sorbent and pore characteristics), and mechanical energy/agitation is applied, using commercially available mixers/granulators, creating Ca(OH)₂ granules that are ready for transport.

### Calcium Hydroxide Granules

In some embodiments, manufactured calcium hydroxide granules have measurable characteristics or properties. For example, the manufacturing process creates Ca(OH)₂ granules with some or all of the following properties:
Mass percentage of granule that is Ca(OH)₂ is >75% (measured via TGA).
Mass percentage of granules that is Mg, Al, Si, K, Fe, Co, Ni, Cu, Zn, Y, Ce and/or other transition metal elements is between 0.1-10% (measured via ICP-MS and dissolution in an acidic medium). These elements exist in oxide, hydroxide, sulfate and/or carbonate form.
A given physical width, height or depth of a granule is in the range of 0.5 mm-15 mm.
The bulk density of the freshly-slaked granule is between 0.45 g/mL-0.95 g/mL.
The Brunauer-Emmett-Teller (BET) surface area of the granule will be between 10-105 m²/g (BET/BJH experiments followed ISO 9277:2022 guidelines at a temperature of 77 K but were conducted with Nitrogen (N₂) gas adsorption and the BET instrument static mode. Granule samples were outgassed at 120° C. for 4 h prior to the sorption measurements. The BET equation was used to calculate the specific surface area from the adsorption data in the P/P0 range between 0.05 and 0.3).
The granule's Brunauer-Emmett-Teller (BET) hysteresis loop of the adsorption-desorption isotherm is a mixture of type III and/or type IV (measured via standard BET methodology described in above bullet point).

### Application of Calcium Hydroxide Granules for Carbon Capture

In some embodiments, the manufactured calcium hydroxide granules are applied to a field where the granules are left in situ in the field to capture ambient CO₂. The duration the granules are left in the field may be based on considerations, such as temperature, humidity and other environmental factors. In some embodiments, the applied calcium hydroxide granules are left in the field for a period of many days or weeks to capture ambient CO₂. For example, the calcium hydroxide granules may be let in the field from a range of about 1 to 5 weeks.

Referring back to FIG. 1, in step 6A, heavy machinery transports the Ca(OH)₂ granules to fields. The calcium hydroxide granules may be applied to the field using heavy machinery, such as bulldozers, dump trucks, skid-steer loaders, overland conveyors, spreaders, etc.

In step 6B, Ca(OH)₂ granules are spread in layers of defined depth across the fields.

In step 6C, Ca(OH)₂ in the granules passively reacts with CO₂ on the air forming CaCO₃

In step 6D, additional Ca(OH)₂ granules are spread in layers on top of the granules that have been carbonated to CaCO₃. In some embodiments, additional layers of granules may be previously applied granules. For example, a first layer of granules may be applied to a field. After a period of time, such as a number of days or weeks, a second layer of granules may be applied over the previously applied granules. Additional layers may be subsequently applied over the second layer.

In step 6E. Steps 6A-6D are repeated on a staggered periodic time basis, such as a daily and/or a weekly basis.

### Recovery and Recycling of Calcium Hydroxide Granules

In some embodiments, the previously applied calcium hydroxide granules may be recovered and recycled. The recycling of the previously applied calcium hydroxide granules creates refreshed or renewed calcium hydroxide granules that may be applied again to a field to capture ambient CO₂. As a result of the recovery and recycling process, the CO₂ that was captured by the previously applied calcium hydroxide granules are extracted from the granules and stored in a storage container, such as in a liquified form. The extracted CO₂ may be transported and stored elsewhere or the extracted CO₂ may be used for other purposes.

Referring now to FIG. 1, in step 7, heavy machinery removes the carbonated CaCO₃ granules from the fields.

In step 8, The carbonated CaCO₃ granules are stored before being fed back into the kiln (to start the process again from step 2).

In step 9, gas (importantly constituent CO₂) that exits the kiln as off-gas from step 2 is directed for further conditioning. The off-gas is cooled and residual heat is redirected for use elsewhere.

In step 10, lime dust is separated from the off-gas.

In step 11, induced fans are used to maintain a negative pressure and a consistent gas volumetric flow.

In steps 12 and 13, the off-gas is treated under ‘wet scrubbing’ conditions, where gaseous impurities such as NOₓ/SOₓ are removed as a slurry of calcium salts.

In step 14, the off-gas is compressed and excess humidity is removed (for re-use elsewhere in the plant).

In step 15, depending on the requirements for the sequestration technique, sometimes a single-point capture technique is used. Using regenerative amine or organic acid solutions can be used to separate CO₂ from the other off-gases e.g. increasing it from 30 to >90% volume_{CO2}.

In step 16, the CO₂ is then sequestered under caprock.

Additional examples relating to the methods of manufacture and of use of calcium hydroxide granules for carbon dioxide capture:
A. Raw minerals and various alkali/transition metal salts could be added during step 2 of the process. Depending on the metal salt, this can result in the formation of defects (higher surface area and porosity) and less stable sorbent lattices, causing an increase of carbonation rates during step 6 (increasing the frequency of layer spreading). Such additives could be alumina, ceria, bauxite, and hemimorphite; amongst others.
B. Raw minerals and various alkali/transition metal salts could be added during step 4 of the process. Depending on the metal salt, this could result in the lowering of the calcination temperature and Tamman temperature of the resultant carbonate granules-increasing the number of cycles the sorbent can perform whilst simultaneously saving energy when recycling granules in the kiln during step 2. Such additives could be forsterite, olivine, potash or soda ash; amongst others.
C. Alkali and transition metal carbonates added during step 4/5 of the process, to help carbonation rate by providing seed crystals (increasing the frequency of layer spreading). Such additives could be raw limestone and/or magnesite; amongst others.
D. Addition of fresh limestone/carbonates, dust emissions, or other solid process waste during slaking/granulation to enhance carbonation rates by altering density, increasing porosity, and/or changing crystallization properties (similar to C).
E. Biomass additives during step 4 of the process, to provide a higher surface area for granules on a microporous level, increasing carbonation rates during step 6 (increasing the frequency of layer spreading). Such biomass could be waste sugarcane bagasse, crop husk/waste, or potato starch; amongst others.
F. Biomass additives before calcination to act as fuel for system, thus decreasing energy expenditure.
G. Ash/impurities from biomass could affect physical/chemical properties of finished granules, enhancing carbonation rates.
H. Physical, thermally-resistant “spacers” mixed into the fresh granules during step 6A to increase air flow throughout carbonation fields, increasing carbonation rates during step 6 (increasing the frequency of layer spreading). Such physical spreaders could be bored and hollowed steel or tungsten spheres; amongst others.
I. Agitation or shifting of granules on the field periodically to enhance carbonation rates during step 6 (increasing the frequency of layer spreading).
J. Using retention pond with aeration (re-saturation of carbon dioxide) to carbonate hydroxide runoff during step 6.
K. Utilizing retention pond water to provide cooling/removal of process heat.
L. Introducing calcium oxide from calcination into a retention pond (replacing steps 3, 4, &5). Oxides would convert to hydroxides with retention pond water, then carbonate using saturated carbon dioxide in retention pond. Enhanced/increased saturation rates could be done with increased aeration techniques.
M. Utilize retention pond composed of limestone (quarry pit) for alternative carbonate/bicarbonate formation/conversion.
N. Aeration of retention pond composed of limestone to increase bicarbonate formation.
O. Carbonate and/or hydroxide slurry from retention pond can be pumped to carbonation fields/dry land and allowed to continue to carbonate and dewater.
P. Carbonate/Hydroxide saturated water from retention pond used for slaking/granulation (5).
Q. Water from a retention pond, other process water, or other water can be used to irrigate the fields of sorbent, increasing local humidity of the granules and layers.
R. Irrigation water from (Q) may also contain bicarbonates, thus releasing CO₂ around the granules upon drying and increasing carbonation rates.
S. Excess steam from step 5 can be used for heat recovery/turbine generation.
T. Exfoliation of hydroxide layers during step 5 with the aqueous miscible solvent method (AMO), increase surface area per gram of fresh granules; enhancing carbonation rates during step 6 (increasing the frequency of layer spreading).
U. Temperature controlled slaking during step 5, making more homogenous sized granules and consistent loading of recycled granules during step 2 (increasing efficiency of downstream processes such as the wet scrubbing in steps 12/13).
V. Reducing calcination temperature and/or adding fresh crushed limestone in step 2 for recycled granules to increase percentage of ‘inert’ material-reducing the amount and extent of sintering of the recycled sorbent to maintain lime reactivity and pore volume for steps 5 onwards.
W. Between steps 5 and 6A, granules can be further wetted or dried. The extent of this can be performed according to the weather forecasted over the two weeks after granule synthesis to better align the local, effective environment experienced by the granule with the optimal humidity for the carbonation reaction.
X. Pre-carbonation of granules using modified atmosphere (increased carbon dioxide). Could enhance crystallization, provide a protective “shell” and enhance handling and/or lower initial solubility from rain/irrigation.
Y. Forming large blocks of the sorbent for more efficient transportation/vertical stacking for reduced land use.
Z. Using compression techniques during/in place of granulation (5) to form sorbent of various characteristics.

### EXAMPLES

It will be appreciated that the present disclosure may include any one and up to all of the following examples and their combinations.

Example 1. A method of manufacturing calcium hydroxide granules comprising: feeding a volume of crushed limestone into a kiln, wherein the crushed limestone comprises an amount of calcium carbonate; heating the crushed limestone, via the kiln, to at least 800° C. and causing a calcination reaction of the calcium carbonate; liberating from about 70.0-99.75% of available CO2 of the crushed limestone in the calcination reaction of the calcium carbonate (CaCO3) to calcium oxide (CaO), wherein the liberated CO2 is captured in a pressurized container; cooling the calcium oxide and storing the cooled calcium oxide in a container; and slaking the calcium oxide by applying water along with agitation of the calcium oxide thereby making calcium hydroxide (Ca(OH)2) granules.

Example 2. The method of Example 1, wherein the crushed limestone has an amount of calcium hydroxide (Ca(OH)2))<3% of a volume of the crushed limestone.

Example 3. The method of any one of Examples 1-2, further comprising: crushing a feed stock of mined limestone to create the crushed limestone, wherein the crushed limestone has a size of between about 0.25-10 mm.

Example 4. The method of any one of Examples 1-3, wherein the calcium oxide is cooled to a temperature range of about 100° C. before slaking the calcium oxide.

Example 5. The method of any one of Examples 1-4, wherein the applied water is in amount to make an amount of the calcium hydroxide granules.

Example 6. The method of any one of Examples 1-5, wherein the made calcium hydroxide (Ca(OH)2) granules comprise a bulk density of between 0.45 g/mL to 0.95 g/mL.

Example 7. The method of any one of Examples 1-6, wherein the made calcium hydroxide (Ca(OH)2) granules comprise a mass percentage of Ca(OH)2 is >75%.

Example 8. The method of any one of Examples 1-7, wherein the made calcium hydroxide (Ca(OH)2) granules comprise a percentage of granules that including the any one or more of the elements Mg, Al, Si, K, Fe, Co, Ni, Cu, Zn, Y, Ce and/or other transition metal elements is between 0.1-10%.

Example 9. The method of any one of Examples 1-8, wherein the any one or more elements exist in an oxide, a hydroxide, a sulfate and/or a carbonate form.

Example 10. The method of any one of Examples 1-9, wherein a plurality of the made calcium hydroxide (Ca(OH)2) granules have physical width, height or depth in the range of 0.5 mm to 15 mm.

Example 11. The method of any one of Examples 1-10, wherein a Brunauer-Emmett-Teller (BET) surface area of at least one of the made calcium hydroxide (Ca(OH)₂) granules is between 10 to 105 m2/g.

Example 12. Calcium hydroxide granules wherein the granules comprise: a mass percentage of Ca(OH)2 is >75%; and a bulk density of between 0.45 g/mL to 0.95 g/mL.

Example 13. The calcium hydroxide granules of Example 12, wherein the granules comprise a percentage of granules that including the any one or more of the elements Mg, Al, Si, K, Fe, Co, Ni, Cu, Zn, Y, Ce and/or other transition metal elements is between 0.1-10%.

Example 14. The calcium hydroxide granules of claim 13, wherein the elements exist in an oxide, a hydroxide, a sulfate and/or a carbonate form.

Example 15. The calcium hydroxide granules of claim 12, wherein a plurality of granules have physical width, height or depth in the range of 0.5 mm to 15 mm.

Example 16. The calcium hydroxide granules of claim 12, wherein a Brunauer-Emmett-Teller (BET) surface area of a granule is between 10 to 105 m2/g.

Example 17. A method comprising: applying calcium hydroxide granules to a field; and recovering from the field, previously applied calcium hydroxide granules; wherein the applied calcium hydroxide granules comprise: a mass percentage of Ca(OH)2 is >75%.

Example 18. The method of Example 17, where the applied calcium hydroxide granules comprise a bulk density of between 0.45 g/mL to 0.95 g/mL.

Example 19. The method of any one of Examples 17-18, wherein the granules comprise a percentage of granules that including the any one or more of the elements Mg, Al, Si, K, Fe, Co, Ni, Cu, Zn, Y, Ce and/or other transition metal elements is between 0.1-10%.

Example 20. The method of any one of Examples 17-19, wherein the any one or more elements exist in an oxide, a hydroxide, a sulfate and/or a carbonate form.

Example 21. The method of any one of Examples 17-20, wherein a plurality of granules have a physical width, height or depth in the range of 0.5 mm to 15 mm.

Example 22. The method of any one of Examples 17-21, wherein a Brunauer-Emmett-Teller (BET) surface area of a granule is between 10 to 105 m2/g. 23. The method of claim 17, further comprising: storing the recovered calcium hydroxide granules to a storage area or container.

Example 23. The method of any one of Examples 17-22, further comprising: feeding a volume of the recovered calcium hydroxide granules into a kiln, the recovered calcium hydroxide granules comprising calcium carbonate; heating the recovered hydroxide granules, via the kiln, to at least 800° C. and causing a calcination reaction of the calcium carbonate; liberating from about 70.0-99.75% of available CO2 of the recovered granules in the calcination reaction of the calcium carbonate (CaCO3) to calcium oxide (CaO), wherein the liberated is the liberated CO2 is captured in a pressurized container; cooling the calcium oxide and storing the cooled calcium oxide in a container; and slaking the calcium oxide by applying water along with agitation of the calcium oxide thereby making renewed calcium hydroxide (Ca(OH)2) granules.

Example 24. The method of any one of Examples 17-23, further comprising: separating lime-dust from off-gas, where the off-gas is created during the heating of the recovered calcium hydroxide granules.

Example 25. The method of any one of Examples 17-24, further comprising: treating the off-gas under wet scrubbing conditions, where gaseous impurities comprising NOx and/or SOx are removed as a slurry of calcium salts.

Example 26. The method of any one of Examples 17-25, further comprising: applying an amount of renewed calcium hydroxide granules to the field.

Example 27. The method of any one of Examples 17-26, further comprising: recovering from the field, the applied renewed calcium hydroxide granules.

Example 28. The method of any one of Examples 17-27, wherein the previously applied calcium hydroxide granules were left in situ in the field for a period of a range of 1-5 weeks to capture ambient CO2.

Example 29. The method of any one of Examples 17-28, wherein the applied renewed calcium hydroxide granules are left in situ in the field for an amount of time in a range of about 1-5 weeks to capture ambient CO2.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

In the preceding description, for purposes of explanation, numerous details are set forth in order to provide a thorough understanding of the embodiments. However, it will be apparent to one skilled in the art that these specific details are not required. In other instances, well-known mechanical structures, electrical structures and circuits are shown in generalized or block diagram form in order not to obscure the understanding. For example, specific details are not provided as to whether the embodiments described herein are implemented as a software routine, hardware circuit, firmware, or a combination thereof.

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method of manufacturing calcium hydroxide granules comprising:
feeding a volume of crushed limestone into a kiln, wherein the crushed limestone comprises an amount of calcium carbonate;
heating the crushed limestone, via the kiln, to at least 800° C. and causing a calcination reaction of the calcium carbonate;
liberating from about 70.0-99.75% of available CO₂ of the crushed limestone in the calcination reaction of the calcium carbonate (CaCO₃) to calcium oxide (CaO), wherein the liberated CO₂ is captured in a pressurized container;
cooling the calcium oxide and storing the cooled calcium oxide in a container; and
slaking the calcium oxide by applying water along with agitation of the calcium oxide thereby making calcium hydroxide (Ca(OH)₂) granules.

2. The method of claim 1, wherein the crushed limestone has an amount of calcium hydroxide (Ca(OH)₂))<3% of a volume of the crushed limestone.

3. The method of claim 1, further comprising:
crushing a feed stock of mined limestone to create the crushed limestone, wherein the crushed limestone has a size of between about 0.25-10 mm.

4. The method of claim 1, wherein the calcium oxide is cooled to a temperature range of about 100° C. before slaking the calcium oxide.

5. The method of claim 1, wherein the applied water is in amount to make an amount of the calcium hydroxide granules.

6. The method of claim 1, wherein the made calcium hydroxide (Ca(OH)₂) granules comprise a bulk density of between 0.45 g/mL to 0.95 g/mL.

7. The method of claim 1, wherein the made calcium hydroxide (Ca(OH)₂) granules comprise a mass percentage of Ca(OH)₂ is >75%.

8. The method of claim 1, wherein the made calcium hydroxide (Ca(OH)₂) granules comprise a percentage of granules that including the any one or more of the elements Mg, Al, Si, K, Fe, Co, Ni, Cu, Zn, Y, Ce and/or other transition metal elements is between 0.1-10%.

9. The method of claim 8, wherein the any one or more elements exist in an oxide, a hydroxide, a sulfate and/or a carbonate form.

10. The method of claim 1, wherein a plurality of the made calcium hydroxide (Ca(OH)₂) granules have physical width, height or depth in the range of 0.5 mm to 15 mm.

11. The method of claim 1, wherein a Brunauer-Emmett-Teller (BET) surface area of at least one of the made calcium hydroxide (Ca(OH)₂) granules is between 10 to 105 m²/g.

12. Calcium hydroxide granules wherein the granules comprise:
a mass percentage of Ca(OH)₂ is >75%; and
a bulk density of between 0.45 g/mL to 0.95 g/mL.

13. The calcium hydroxide granules of claim 12, wherein the granules comprise a percentage of granules that including the any one or more of the elements Mg, Al, Si, K, Fe, Co, Ni, Cu, Zn, Y, Ce and/or other transition metal elements is between 0.1-10%.

14. The calcium hydroxide granules of claim 13, wherein the elements exist in an oxide, a hydroxide, a sulfate and/or a carbonate form.

15. The calcium hydroxide granules of claim 12, wherein a plurality of granules have physical width, height or depth in the range of 0.5 mm to 15 mm.

16. The calcium hydroxide granules of claim 12, wherein a Brunauer-Emmett-Teller (BET) surface area of a granule is between 10 to 105 m²/g.

17. A method comprising:
applying calcium hydroxide granules to a field; and
recovering from the field, previously applied calcium hydroxide granules;
wherein the applied calcium hydroxide granules comprise:
a mass percentage of Ca(OH)₂ is >75%.

18. The method of claim 17, where the applied calcium hydroxide granules comprise a bulk density of between 0.45 g/mL to 0.95 g/mL.

19. The method of claim 17, wherein the granules comprise a percentage of granules that including the any one or more of the elements Mg, Al, Si, K, Fe, Co, Ni, Cu, Zn, Y, Ce and/or other transition metal elements is between 0.1-10%.

20. The method of claim 18, wherein the any one or more elements exist in an oxide, a hydroxide, a sulfate and/or a carbonate form.

21. The method of claim 17, wherein a plurality of granules have physical width, height or depth in the range of 0.5 mm to 15 mm.

22. The method of claim 17, wherein a Brunauer-Emmett-Teller (BET) surface area of a granule is between 10 to 105 m²/g. 23. The method of claim 17, further comprising: storing the recovered calcium hydroxide granules to a storage area or container.

23. The method of claim 17, further comprising:
feeding a volume of the recovered calcium hydroxide granules into a kiln, the recovered calcium hydroxide granules comprising calcium carbonate;
heating the recovered hydroxide granules, via the kiln, to at least 800° C. and causing a calcination reaction of the calcium carbonate;
liberating from about 70.0-99.75% of available CO₂ of the recovered granules in the calcination reaction of the calcium carbonate (CaCO₃) to calcium oxide (CaO), wherein the liberated is the liberated CO₂ is captured in a pressurized container;
cooling the calcium oxide and storing the cooled calcium oxide in a container; and
slaking the calcium oxide by applying water along with agitation of the calcium oxide thereby making renewed calcium hydroxide (Ca(OH)₂) granules.

24. The method of claim 23, further comprising:
separating lime-dust from off-gas, where the off-gas is created during the heating of the recovered calcium hydroxide granules.

25. The method of claim 23, further comprising:
treating the off-gas under wet scrubbing conditions, where gaseous impurities comprising NOₓ and/or SOₓ are removed as a slurry of calcium salts.

26. The method of claim 17, further comprising:
applying an amount of renewed calcium hydroxide granules to the field.

27. The method of claim 26, further comprising:
recovering from the field, the applied renewed calcium hydroxide granules.

28. The method of claim 26, wherein the previously applied calcium hydroxide granules were left in situ in the field for a period of a range of 1-5 weeks to capture ambient CO₂.

29. The method of claim 26, wherein the applied renewed calcium hydroxide granules are left in situ in the field for an amount of time in a range of about 1-5 weeks to capture ambient CO₂.
